(19) United States
(12) Patent Application Publication
(10) Pub. No.: US 2012/0199412 A1
(43) Pub. Date: Aug. 9, 2012

(54) Ball Screw And Steering Device Equipped With The Same

(76) Inventor: Torsten Kluge, Overath (DE)

(21) Appl. No.: 13/358,837

(22) Filed: Jan. 26, 2012

(30) Foreign Application Priority Data
Feb. 3, 2011 (DE) 102011003562.1

(51) Int. Cl. B62D 5/04; B62D 3/08; F16H 25/22

(52) U.S. Cl. 180/444; 74/424.81; 74/89.23

(57) ABSTRACT

Described is a ball screw for a steering device of a motor vehicle, which ball screw has a threaded spindle (2) and a nut (3) having a nut body which runs on the threaded spindle (2) via balls (4) guided in ball channels, wherein the nut body has a first body element (5) and a second body element (6) which interact via at least one elastic damping body (7) arranged between them.

Also described is a steering device for a motor vehicle, in which the ball screw according to the invention is used.

The present invention relates to a ball screw, in particular for a steering device of a motor vehicle, as per the preamble of claim 1, and to a steering device equipped with the same, as per the preamble of claim 8.

Ball screws are used in a variety of applications for example in automotive engineering. One specific application in which particularly high demands are placed on the production accuracy of the ball screw is the use of a ball screw in or as part of a steering device of a motor vehicle. A steering device of said type comprises a steering housing in which a toothed rack, which is in geared connection with a steering column, is mounted in an axially movable manner for the purpose of deflecting vehicle wheels. By means of the movement of the toothed rack, the steer angle is varied in a known way, that is to say, the toothed rack is coupled to the wheels to be steered, whether they be front or rear wheels, via corresponding transverse links and similar mechanical connections.

To assist the driver when steering, the ball screw is provided, which ball screw comprises a threaded spindle which is coupled to the toothed rack, that is to say is connected into the longitudinally movable mechanical strand. When the toothed rack moves, the threaded spindle is likewise moved. The nut, which in this case is positionally fixed, runs on the threaded spindle in a known way. The nut may be driven for example by means of a drive motor via a belt. The steering movement initiated by the driver is assisted by means of said motor in that the nut is actively rotated and, as a result, the threaded spindle, and with it the toothed rack, or the entire mechanism, is moved. Such a steering device is also referred to as an electric or electrically driven servo steering system with a toothed-rack drive rack-type EPAS, EPAS=Electric Power Assisted Steering).

Very high demands are placed on the accuracy of a ball screw to be integrated in a steering device of said type. In particular, the axial play between the nut and spindle is defined as being very small (for example a few μm). By means of a very small amount of play, it is possible firstly to realize a highly precise steering system, and secondly, the generation of clacking noises should be prevented.

Clacking noises in the ball screw on account of axial play may arise for example because the rotation of the nut taking place during the operation of the ball screw generates a parameter-induced vibration, in which the nut moves relative to the threaded spindle in the form of a limit cycle. It is known per se that, in the case of rotating machine parts of said type, such as for example the nut, vibrations can arise in the machine parts as a result of the inherent operation of the machine (in this case: of the ball screw) or else as a result of external excitation. This is promoted in particular in that the machine parts in general have little material damping.

In contrast, if the axial play is undershot, a situation may arise in which the balls are guided between the spindle and nut under preload. This in turn is disadvantageous because, in this way, the steering becomes stiffer because in this case the preloaded balls counteract the steering movement or spindle rotation. Furthermore, in the case of conventional ball screws with a ball chain in which the balls bear against one another, a slip-stick effect may arise in which the balls may adhere to one another and therefore do not roll correctly. A very small axial play or even zero axial play between nut and threaded spindle can be maintained only with a considerably large amount of production outlay, and in the case of conventional ball screws, it is possible with reasonable outlay for said very small play to at best be approximately attained, but not completely eliminated.

DE 10 2007 039 733 A1 discloses a steering device for a motor vehicle, having a steering housing, an electric motor and a thrust rod for the purpose of deflecting vehicle wheels, wherein a gearing device is provided in the steering housing, which gearing device has a plurality of rotationally movable gearing elements for transmitting force from the electric motor to the thrust rod. A torque generated by the electric motor is transmitted from there via an output shaft or rotor shaft firstly to a belt drive. The belt drive is part of the gearing device and comprises further gearing elements, specifically a first belt pulley which is attached to the rotor shaft, a second belt pulley which is attached to a steering nut, and a belt which connects the two belt pulleys to one another. The steering nut is part of a recirculating ball mechanism and engages with a ball screw attached to the thrust rod.

Against this background, it is the object of the present invention to specify a ball screw which is suitable in particular for use in a steering device of a motor vehicle, and a steering device of said type, wherein the ball screw and the steering device equipped therewith, while being of the simplest possible design, offer good optimization possibilities with regard to the vibrational behavior of the ball screw, and therefore the generation of undesired clacking noises is prevented in an effective manner.

Said object is achieved by means of a ball screw having the features of claim 1 and by means of a steering device, equipped with said ball screw, for a motor vehicle, having the features of claim 8. Further particularly advantageous refinements of the invention are disclosed in the subclaims.

It is pointed out that the features specified individually in the claims may be combined with one another in any desired technologically meaningful way and disclose further embodiments of the invention. The description, in particular in conjunction with the figures, characterizes and specifies the invention further.

According to the invention, a ball screw for a steering device of a motor vehicle has a threaded spindle and has a nut having a nut body which runs on the threaded spindle via balls guided in ball channels. The nut body has a first body element and a second body element which interact via at least one elastic damping body arranged between them. The division of the nut body into two individual body elements and the coupling of said two body elements by means of at least one elastic damping body makes it possible for the vibrational behavior of the ball screw, in particular the vibrational behavior of the nut and of the threaded spindle, to be influenced in a targeted manner.

The vibration isolation of the individual body elements or body masses and the elastically damping coupling between these makes it possible, by means of a suitable selection and targeted specification of vibration parameters, such as for example the masses of the vibrating bodies, the stiffness and the damping of the damping body, to optimize the vibrational behavior of the ball screw according to the invention with regard to a (complete) elimination of vibrations. With the design of the nut according to the invention, a compact design of the ball screw is likewise obtained, by means of which the vibrations of the nut relative to the threaded spindle at certain (rotational) frequencies or in a certain (rotational) frequency range can be reduced. The generation of clacking noises caused by the vibrational behavior of the nut and of the threaded spindle can be prevented in an effective manner by means of said design.

The abovementioned parameters for controlling the vibrational behavior of the ball screw or of the nut and of the threaded spindle, in particular the mass, the stiffness or elasticity and the damping, can be defined for example by selecting a damping body with suitable stiffness/elasticity and damping and by designing the two body elements so as to have suitable masses. Here, the first body element expediently forms a main mass of the nut, which can be adapted in a simple manner relative to the mass of the second body element for a defined vibrational behavior.

One advantageous embodiment of the invention provides that the second body element is arranged coaxially with respect to and spaced apart from the first body element, because said design permits a further optimization of the vibrational properties of the ball screw while at the same time providing a compact and simple arrangement. In this context it is advantageous for the damping body arranged between the body elements to be of annular design. The coaxial arrangement of the body elements, in particular an arrangement in which the second body element is coaxial with respect to and radially spaced apart from the first body element, also provides a further, easily variable parameter for the vibrational optimization of the ball screw, specifically the radial spacing between the first and second body elements. With said spacing, the mass moment of inertia of the second body element with respect to the rotation of the nut can be defined without the need to substantially change the mass of the second body element itself.

In one advantageous embodiment of the invention, for further optimization of the vibrational properties of the ball screw according to the invention, the damping body has a greater stiffness in the radial direction than in the tangential direction. The damping body therefore has an elastically damping action primarily in the direction of rotation in order to be able to compensate the mass inertia of the first and second body elements.

In one advantageous embodiment of the invention, the damping body is vulcanized in between the first and the second body element, that is to say the damping body is expediently a correspondingly suitable natural rubber/natural rubber mixture or a suitable elastomer/elastomer mixture. A secure connection of the damping body to the respective body element is thereby ensured. Furthermore, it is possible in a manner known per se for the desired elasticity, stiffness, damping and temperature properties of the damping body to be defined by means of the starting materials which form the damping body, and the composition of said starting materials.

As already mentioned, the damping body may be vulcanized in directly between the body elements, which permits a particularly compact design of the nut. Alternatively, however, the damping body, in particular an annular damping body, may have in each case one sleeve for example a metal sleeve on its inner circumference and its outer circumference, between which sleeves said damping body is vulcanized. The outer sleeve of the damping body is then expediently pressed with an interference fit into the in circumference of a second body element, which is for example likewise of annular form, and the inner sleeve of the damping body is correspondingly pressed with an interference fit onto the outer circumference of an annular first body element, as a result of which the assembly of the damping body is simplified. Instead of an interference fit, the respective sleeves may also be connected to the respective body elements using other suitable connecting techniques, such as for example adhesive bonding. The damping body may likewise be connected to the respective body directly, that is to say without the sleeves described above, by means of adhesive bonding, screws, rivets, pressing and the like.

In one advantageous embodiment of the invention, the contact surface of the first body element and/or of the second body element has a profiling for the damping body. The profiling serves to ensure secure seating of the damping body on the respective body element, such that the damping body for example cannot be moved relative to the body elements in the axial direction and/or tangential direction.

A further advantageous embodiment of the invention provides a belt seat on the second body element for accommodating a drive belt on the outer circumference of the second body element. In particular, the second body element has on its outer circumference at least one for example v-shaped or rectangular groove, in which the drive belt, which is wrapped around the second body element, is guided in a stable manner. The drive belt drives the entire nut on the threaded spindle via the operative connection provided between the second body element, the damping body and the first body element. The drive belt itself may be driven for example via an electric motor, to the drive output shaft of which a further belt pulley is connected for conjoint rotation therewith, around which further belt pulley the drive belt is likewise wrapped. In said embodiment, the ball screw according to the invention is particularly suitable for use in a steering device of a motor vehicle in which an electric or servo motor transmits a steering force via the ball screw to the toothed rack, which is connected to the threaded spindle, for the purpose of pivotally deflecting the vehicle wheels.

A steering device of said type generally has a steering housing in which a toothed rack, which is in geared connection with a steering column, and a threaded spindle, which is connected to the toothed rack and which is part of a screw, are mounted in an axially movable manner for the purpose of deflecting vehicle wheels. In a preferred embodiment, the second body element has, on the outer circumference, a belt seat for accommodating a drive belt wherein the drive belt can be driven by means of an electric motor which is arranged on the steering housing, for example in a so-called axially parallel arrangement. Furthermore, the nut is mounted, for example on the steering housing, so as to be positionally fixed with respect to the threaded spindle. Therefore, the rotation of the nut causes a movement of the toothed rack or threaded spindle in the axial direction, that is to say the ball screw converts a rotational movement of the nut into a longitudinal movement of the toothed rack for the purpose of deflecting the vehicle wheels.

The ball screw according to the invention particularly advantageously has a simple and compact design and furthermore offers good optimization possibilities for targetedly influencing the vibrational properties of the ball screw with regard to preventing undesired clacking noises, that is to say in particular for actively reducing the tendency of the nut to vibrate for a certain (rotational) frequency or for a certain (rotational) frequency range.

Further advantageous details and effects of the invention are explained in more detail below on the basis of an exemplary embodiment illustrated in the single figure. In the figure:

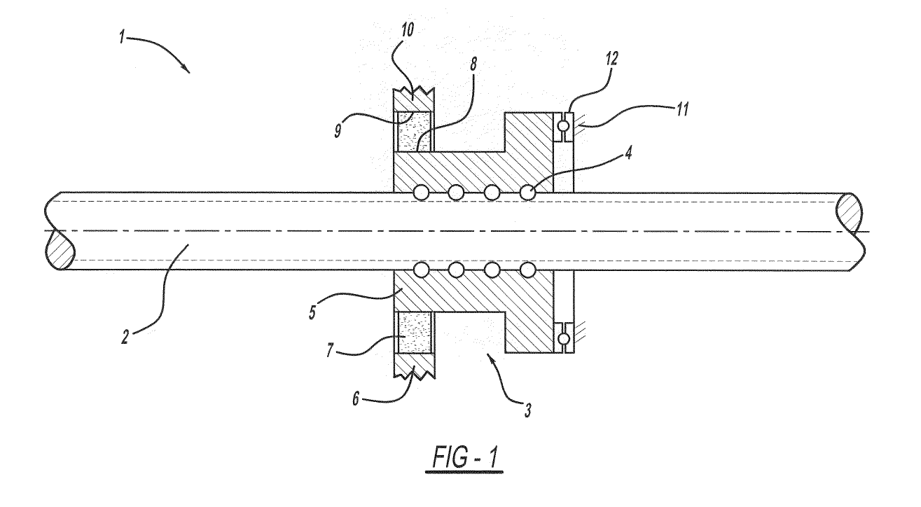

FIG. 1 shows a schematic side-on sectional view of a ball screw according to the invention.

FIG. 1 schematically shows an exemplary embodiment of a ball screw 1 according to the invention in a side-on sectional view. The ball screw 1 comprises a threaded spindle 2 and also a nut 3 which runs on the threaded spindle 2 in each case via balls 4 guided in ball channels. The nut 3 is likewise referred to as recirculating ball nut of the ball screw 1. The precise design of said nut, in particular the profile of the ball channels and the ball returns assigned to the ball channels, is not illustrated in any more detail in FIG. 1. Said design is known per se.

The nut 3 has a first body element 5 and a second body element 6 which are operatively connected to one another via an elastic amp ding body 7. The damping body 7 can be arranged between the first body element 5 and the second body element 6. In the exemplary embodiment shown in FIG. 1, the body elements 5 and 6 are in each case rotationally symmetrical, for example cylindrical elements, wherein the second body element 6 is arranged coaxially with respect to and spaced apart from the first body element 5. In particular, the second body element 6 is arranged coaxially with a radial spacing around an outer circumferential surface 8 of the first body element 5. The body elements 5 and 6 therefore form an annular intermediate space between the outer circumferential surface 8 of the first body element 5 and the inner circumferential surface 9 of the second body element 6. The damping body 7 is formed annularly between the body elements 5 and 6. A compact design of the nut 3 and of the entre ball screw 1 can therefore be realized.

The damping body 7 is for example vulcanized in between the body elements 5 and 6 for a secure seat. Alternative connecting techniques, such as for example adhesive bonding, pressing, rivets, screws and the like, may likewise be used for connecting the damping body 7 to the respective body elements 5, 6. It is likewise possible for the damping body 7 illustrated in FIG. 1 to be surrounded on its outer circumference and inner circumference in each case by a sleeve, for example a metal sleeve. Such sleeves could then be pressed for example with an interference fit between the first and the second body element 5 and 6 in order to ensure a secure seat of the damping body 7 between the body elements 5 and 6 and facilitate the assembly of the damping body 7.

A further alternative for providing a secure seat of the damping body 7 is to provide the contact surface 8 of the first body element 5 and/or the contact surface 9 of the second body element 6 for the damping body 7 with a profiling. Although such a profiling is not explicitly illustrated in the exemplary embodiment illustrated in FIG. 1, it could however for example comprise a radial recess (radial groove) along the outer circumference 8 and/or the inner circumference 9, in which radial recess the damping body 7 would be held for example in order to prevent an axial movement of the damping body 7. Other profilings of the contact surfaces 8 and/or 9, which profilings prevent for example a tangential movement of the damping body 7 between the respective body elements 5, 6, are likewise possible.

In the exemplary embodiment illustrated in FIG. 1, the second body element 6 is provided, on its outer circumference, with a belt seat 10 for accommodating a drive belt (not illustrated in FIG. 1). In the exemplary embodiment shown, the belt seat 10 has a plurality of v-shaped grooves in which the drive belt is guided in a secure and stable manner. The drive belt is wrapped around the second body element 6 and drives the latter in a manner known per se, that is to say the drive belt is driven for example by an electric motor (likewise not illustrated in FIG. 1). In this way, the ball screw 1 according to the invention is suitable in particular for use in a steering device of a motor vehicle in which an electric or servo motor transmits a steering force via the ball screw 1 to a toothed rack, which is connected to the threaded spindle 2, for the purpose of pivotally deflecting vehicle wheels.

For further optimization of the vibrational properties of the ball screw 1, the damping body 7 has a greater stiffness in the radial direction than in the tangential direction. In the embodiment illustrated in FIG. 1, this yields a separation of the radial and tangential forces exerted on the second body element 6 by the drive belt with regard to the vibration damping. The damping body 7 therefore has an elastically damping action primarily in the direction of rotation in order to compensate the mass inertia of the first and second body elements 5 and 6. In the radial direction, the forces exerted on the second body element 6 by the drive belt are accommodated, substantially undamped, by the damping body 7.

A steering device has for example a steering housing 11 which is schematically illustrated in FIG. 1 and in which a toothed rack, which is in geared connection with a steering column, and a threaded spindle 2, which is connected to the toothed rack and which is part of the ball screw 1 according to the invention, are mounted in an axially movable manner for the purpose of deflecting vehicle wheels. In a preferred embodiment, the second body element 6 has, on the outer circumference, a belt seat 10 for accommodating a drive belt, wherein the drive belt can be driven by means of an electric motor which is likewise arranged on the steering housing 11. The nut 3 is mounted on the steering housing 11 so as to be immovable in the axial direction of the threaded spindle 2, that is to say so as to be positionally fixed with respect to the threaded spindle 2 for example by means of corresponding bearings 12 (ball bearings) visible in FIG. 1 The rotation of the second body element 6 therefore causes a rotation of the first body element 5 and therefore a rotation of the nut 3 and consequently movement of the threaded spindle 2 or the toothed rack in the axial direction. The ball screw 1 accordingly converts a rotational movement of the second body element 6 or nut 3 into a longitudinal movement of the toothed rack for the purpose of deflecting the vehicle wheels.

In a preferred embodiment, the ball screw according to the invention is used in a steering device of a motor vehicle and comprises a threaded spindle and a nut with a nut body which runs on the threaded spindle via balls guided in ball channels. The nut body has a first body element and a second body element which interact via at least one elastic damping body arranged between them. Furthermore, the second body element is arranged coaxially with respect to and radially spaced apart from the first body element, and the damping body is formed annularly between said body elements. The second body element has, on its outer circumference, a belt seat for accommodating a drive belt.

### LIST OF REFERENCE NUMERALS

1 Ball screw
2 Threaded spindle
3 Nut
4 Ball
5 First body element of 3
6 Second body element of 3
7 Elastic damping body
8 Outer circumferential surface of 5, contact surface
9 Inner circumferential surface of 6, contact surface
10 Belt seat
11 Steering housing
12 Ball bearing

1. A ball screw for a steering device of a motor vehicle, comprising a threaded spindle (2) and a nut (3) having a nut body which runs on the threaded spindle (2) via balls (4) guided in ball channels,
wherein
the nut body has a first body element (5) and a second body element (6) which interact via at least one elastic damping body (7) arranged between them.

2. The ball screw as claimed in claim 1,
wherein
the second body element (6) is arranged coaxially with respect to and spaced apart from the first body element (5).

3. The ball screw as claimed in claim 1,
wherein
the damping body (7) is of annular design.

4. The ball screw as claimed claim 1,
wherein
the damping body (7) has a greater stiffness in the radial direction than in the tangential direction.

5. The ball screw as claimed in claim 1,
wherein
the damping body (7) is vulcanized in between the first body element (5) and the second body element (6).

6. The ball screw as claimed in claim 1,
wherein
the contact surface (8) of the first body element (5) and/or the contact surface (9) of the second body element (6) has a profiling for the damping body (7).

7. The ball screw as claimed in claim 1,
wherein
the second body element (6) has, on its outer circumference, a belt seat (10) for accommodating a drive belt.

8. A steering device for a motor vehicle, having a steering housing (11) in which a toothed rack, which is in geared connection with a steering column, and a threaded spindle (2), which is connected to the toothed rack and which is part of a ball screw (1), are mounted in an axially movable manner for the purpose of deflecting vehicle wheels,
wherein
the ball screw (1) is designed as claimed in claim 1.

9. The steering device as claimed in claim 8,
wherein
the second body element (6) has, on the outer circumference, a belt seat (10) for accommodating a drive belt which can be driven by means of an electric motor arranged on the steering housing (11), and the nut (3) is mounted on the steering housing (11) so as to be immovable in the axial direction of the threaded spindle (2).

10. The ball screw as claimed in claim 2,
wherein
the damping body (7) is of annular design.
